(19) United States
(12) Patent Application Publication
(10) Pub. No.: US 2010/0120003 A1
(43) Pub. Date: May 13, 2010

(54) Holistic Approach to Learning to Type

(75) Inventor: Rita P. Herman, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Keyboard Town PALS, LLC, Pittsburgh, PA (US)

(21) Appl. No.: 12/269,916

(22) Filed: Nov. 13, 2008

(51) Int. Cl. G09B 13/00

(52) U.S. Cl. 434/227

(57) ABSTRACT

The present invention is directed to a method of teaching typing wherein the student associates the keys on the keyboard with a person, place, thing or emotion and is able to more readily learn the position of each key. Further, the method of the present invention provides immediate gratification to the student as they are able to instantly visually and auditorily appreciate the accuracy of their typing on a computer monitor or screen that is attached to the keyboard. The delete key and/or backspace key may be inactivated during operation of the program. Further, the color of the letters and background displayed on the monitor or screen may be variable.

### BACKGROUND OF THE INVENTION

1. Field of the Invention

The present invention relates to a visual method for teaching typing.

2. Description of Related Art

The most widely accepted method for efficient keyboard input is the touch typing procedure. In this procedure, the typist places the fingers on the correct home keys across the width of the keyboard, which read “ASDFJKL;” from left to right. The right thumb is placed over the space bar. Each finger rests lightly on its home key and does not move unless it reaches to strike keys immediately above or below the home key, or, in the case of each of the index fingers, the additional two keys immediately to the sides of the home keys. The finger quickly returns to its home key. Thus, each finger has only certain keys that it should strike.

Heretofore, keyboarding has been a skill taught at the high school level. Many suitable teaching systems exist for students of that level. However, the explosive growth in the use of computers has reached as far down as elementary school, and students as young as kindergarteners, if not younger, are now using a computer keyboard to work various computer programs. Even if a program requires the striking of only one or two keys on the keyboard, the students are striking keys with the wrong fingers and using other incorrect keyboarding techniques. Typing teachers agree that students who form incorrect keyboarding techniques are extremely difficult to retrain. It is much more difficult to teach a student who has ingrained, incorrect habits of keyboarding than to teach a student who has never used the keyboard. Breaking incorrect habits is frustrating and next to impossible in many cases.

Young students and/or students with learning disabilities can find it difficult to learn the keys on the keyboard. The keys are not in alphabetical order and even locating a key many times is difficult. Further, many students attempt to strike keys with the incorrect finger. The keyboard is an overwhelming mystery to these students. Moreover, the poor habits that they learn at this age will significantly hamper their ability to learn correct typing procedure. Further, many students of typing find it frustrating that they do not see the results of their typing efforts until after they have completed a lesson or a typing drill. This is because it has been widely thought that one should not look at what they are typing when they are learning how to type. Instead, teachers have instructed students of typing that they should be looking away from what they are typing and at the paper copy from which they are learning to type. One prior art system is disclosed in commonly owned co-pending U.S. application Ser. No. 11/318,962, which is hereby incorporated by reference.

What is needed and has not heretofore been developed is a method of teaching typing that creates an association with the keys on a keyboard and enables the students to have their thoughts automatically presented to a screen in front of them.

### SUMMARY OF THE INVENTION

The present invention is directed to a method of teaching typing wherein the student associates the keys on the keyboard with a person, place, thing or emotion and is able to more readily learn the position of each key. Further, the method of the present invention provides immediate gratification to the student as they are able to instantly visually appreciate the accuracy of their typing on a computer monitor or screen that is attached to the keyboard. The method for teaching a student to type on a computer has the steps of:

a) providing a computer terminal having a first portion and a second portion;

b) providing a keyboard coupled to said terminal;

c) providing a word processing program;

d) correlating keys of the keyboard with stories, wherein the keys of the keyboard represent a fictional town and the stories enable the student to associate a relative location of the keys on the keyboard, and, wherein puppets are used to assist with the step of correlating keys of the keyboard with stories;

e) displaying the stories on the first portion of the terminal; and

f) typing keys on the keyboard and having letters that correlate to the typed keys displayed on the second portion of the terminal for immediate viewing by a student. The letters displayed on the terminal may be of a sufficient size to be easily read by the student. Further, the letters displayed on the terminal may be of different font styles. The stories told by the puppets to the student enable the student to associate the relative location of the keys on the keyboard. At least one of the keys on the keyboard may be texturized. Further, the keys of the keyboard may represent a fictional town. In the method of the present invention and as stated above, the typed keys displayed on the terminal provide an instant gratification for the student. The stories can include auditory and visual features. The colors of the letters and backgrounds on the display can be variable.

The present invention also provides a method for teaching a student to type on a computer having the steps of:

a) telling a student at least one story that correlates individual keys of a keyboard with at least one of a person, place, thing, emotion or expression, wherein the keys of the keyboard represent a fictional town and the at least one story enables the student to associate a relative location of the keys on the keyboard and correlate each key with an appropriate finger of the student to activate the respective key;

b) providing a computer terminal;

c) providing a keyboard having a delete key and/or backspace key coupled to said terminal;

d) providing a word processing program, which inactivates the delete key and/or backspace key during operation of the program by the student;

e) having the student place at least one hand on the keyboard; and

f) retelling the at least one story as the student presses individual keys that correlate to the story while viewing the computer terminal, wherein puppets are used to assist with the step of telling of, retelling of, or both, to the at least one story.

The letters that correlate to the pressed keys are displayed on the terminal for immediate viewing by the student. Further, the stories enable the student to associate the relative location of the keys on the keyboard. The stories can include auditory and visual features. The colors of the letters and backgrounds on the display can be variable.

### BRIEF DESCRIPTION OF THE DRAWINGS

FIG. 1 is a top plan view of a chart that correlates the keys of a keyboard to a story;

FIG. 2 is a top plan view of a chart showing the keys of a QWERTY keyboard;

FIG. 3 is a side perspective view of a child typing at a keyboard and viewing the monitor or screen; and

FIG. 4 is a perspective view of a monitor or screen having a split screen and a keyboard.

### DETAILED DESCRIPTION OF THE INVENTION

For purposes of the description hereinafter, the terms “top”, “bottom”, “left”, “right”, “above”, “below”, and derivatives thereof, shall relate to the invention as it is oriented in the drawing figures. However, it is to be understood that the invention may assume various alternative variations, except where expressly specified to the contrary. Further, many desirable features of the invention will be apparent to those of ordinary skill in the art upon reading the description of the invention, taken with the accompanying figures.

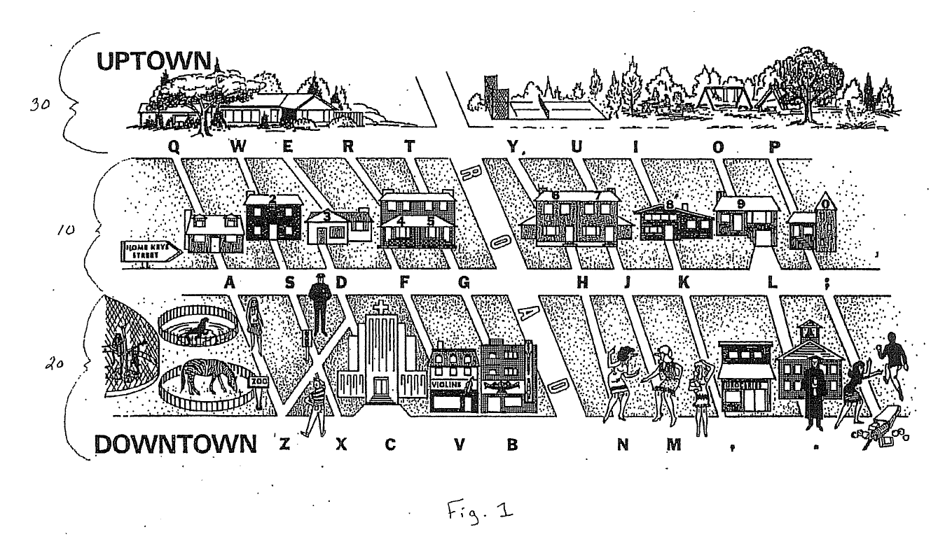

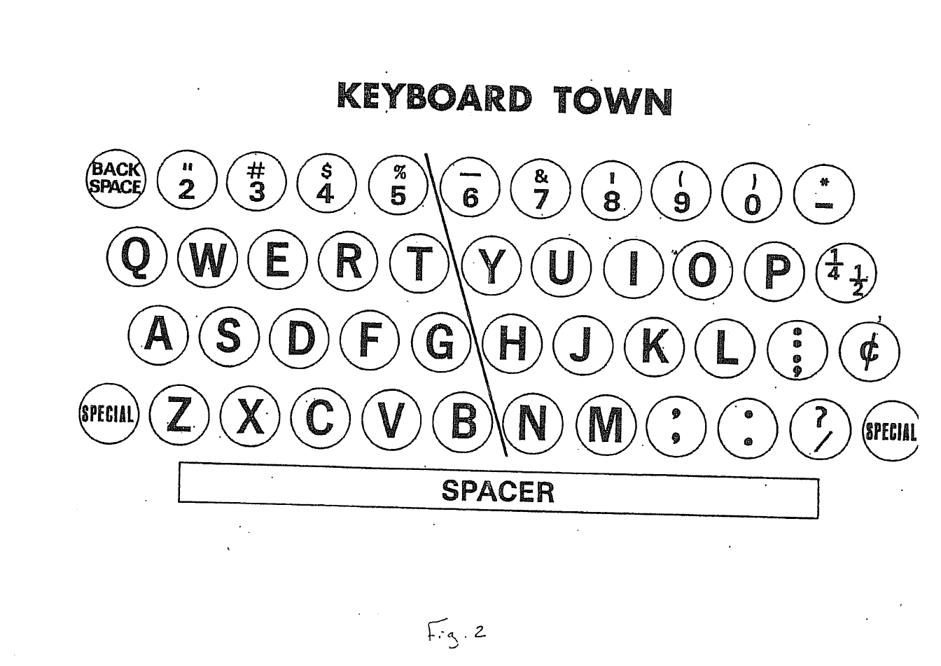

The present invention is a method of teaching typing wherein the student associates auditorily and visually the keys on the keyboard with a person, place, thing or emotion and is able to more readily learn the position of each key. Further, the method of the present invention provides immediate gratification to the student as they are able to instantly visually appreciate the accuracy of their typing on a computer monitor or screen that is attached to the keyboard. The method teaches a student the proper fingering of keys on a keyboard so that communication skills can be automatic going from thought to screen and without looking at the keyboard while typing. Through the use of this method, interpersonal relationships are emphasized and human traits can be identified. FIG. 1 illustrates a chart that correlates the keys of a keyboard to a story. FIG. 2 illustrates a chart showing the keys of a QWERTY keyboard.

In one embodiment of the present invention and as shown in FIG. 1, the method divides the main keys of a standard QWERTY keyboard into three rows. The middle row 10 is the home street. The middle row 10 is where the keys on the keyboard represent people. For instance, the “A” key stands for Amy, the “S” key for Sam, the “D” key for Dora, the “F” key for Frank, and the “G” key for George. The bottom row 20 is where the keys on the keyboard represent people, places or things in downtown. For instance, the “Z” key represents the Zoo and/or Zebras, the “X” key represents Exercise in life, the “C” key represents the sound clue “Cee”, the “V” key represents a Violin store and teacher, and the “B” key represents a Banana. The top row 30 is where the keys on the keyboard represent people, places, things or emotions/expressions. For instance, the “Q” key represents a wizard named Q-Wert that asks a lot of Questions, the “W” key represents “Weights”. The “E” key represents an Eagle. The “R” key represents the sound clue “aRe”. The “T” key represents emotions or expressions like Tough or Trying.

In a first step of this embodiment, the teacher uses puppets, props and stories to quickly familiarize the student with keys of the middle row 10, the bottom row 20 and the top row 30. For example, the teacher could tell a story about Amy, who lives at the “A” key in the middle row 10, and how she went down one row to the downtown bottom row 20 to the Zoo to feed the Zebras, who are located at the “Z” key. Next, Amy went uptown two rows to the top row 30 to see a magician named Q-Wert located at the “Q” key who asked her lots of Questions about her visit to the Zoo. The teacher can also tell a story about Sam, who lives at the “S” key in the middle row 10, and how he went down one row to the downtown bottom row 20 to the “X” key because he is Exercising. He went up two rows to the “W” key to ask himself to “watch the Weights”. The students will begin to learn the location of the individual keys through stories of this type. In a next step, the teacher will tell the stories with the student having their fingers properly positioned on a keyboard that is coupled to a computer terminal that has a word processing program such as Microsoft® Word®. As the story is told auditorily and visually, the students are instructed to move their fingers and press on the keys along with the progression of the character in the story. The movement of the appropriate fingers on each hand is via the standard positions of the fingers to strike the related keys that are presently utilized in the teaching of typing. For example, the left pinky finger rests on the “A” key and is used to press the “Q”, “A”, and “Z” keys. The right pinky finger rests on the semi-colon key and is used to press the “P”,“;”, and “/” keys, etc. This is known as the finger by finger method of typing. So, for example, when Amy is introduced, the student will press the “A” key with their left pinky finger. When Amy goes to the Zoo, the student will move down one row with the same finger and press the “Z” key. When Amy visits Q-Wert, the student will move up two rows with the same finger and press the “Q” key. The student can see the letters they have typed on the monitor or screen of the computer terminal. Alternatively, the present invention could be taught through a television screen coupled to a keyboard and a microprocessor coupled to the television and keyboard, wherein the microprocessor enables the letters for the corresponding pressed keys to be shown on the screen. The student learns the position and relative location of the keys of a keyboard through the use of stories, such as the Amy story, and immediately is able to activate the learned key that he or she has seen on the lower half of the screen. Once the student has heard stories about all of the main keys on the keyboard and has undergone typing exercises, such as the one described above, he/she is able to type efficiently and without having to look down at the keyboard because he/she has learned the location of the keys. Thus, through the association of stories, the student will remember which fingers go with which keys and the relative location of each key. Within a very short period of time, the students can begin keyboarding and expressing their thoughts and opinions and instantly see the expression on the computer monitor or screen.

In one embodiment of the present invention, the letters keyed in by the student are shown on the monitor or screen with choices of fonts, font sizes, colors, and backgrounds to provide more visual definition to the student learning to type who may experience more clarity with the different colors including special needs students, such as dyslexic children. For example, when a student is learning the location of the “A”, “Z”, and “Q” keys via the story about Amy going to the Zoo, the background that the letters appear on may be striped like a Zebra and the font size may be large, for example, 24 point font instead of a 12 point font. Further, a small font size, such as 6 point font instead of a 12 point font may be desired. A small font size could indicate quietness or shyness of the person typing the story or relaying thoughts and expressions. When the student is learning the location of the “S”, “X”, and “W” keys via the story about Sam exercising, the background that the letters appear on may have faint question marks on it and the font style may be bold, like Rockwell Extra Bold style or italicized or underlined to strengthen the association with the student that this is a difficult decision for Sam. It has been found that the large font assists in the student focusing on the skill of typing on a computer keyboard coupled to a computer screen. Further, it helps the student to focus on the screen, not the keyboard. This method results in a higher level of visual expression, as opposed to written expression where the student concentrates on the keys located on the keyboard.

Additionally, the method of the present invention teaches cognitive recognition to the student. For example, the teacher will provide a concrete concept in a first step, such as instructing the student to type Amy and then type Sam. Then the student will be asked to say what they typed, which would be the word “AS”. Next, the student is provided a semi-concrete concept and instructed to type the letter “A” followed by the letter “S”. Again, the word “AS” will show up on the screen. Finally, the student is provided an abstract concept and instructed to type the word “AS”. Again, the word “AS” will show up on the screen. With the aid of various permutations on the “AS” exercise, the student is able to gain cognitive recognition skills.

Further, in another embodiment of the present invention, one or more keys on the keyboard may be provided with texture. For example, the “Z” key may have fur applied to it, so that the student, without looking, will feel the fur underneath their pinky, associate the key with furry animals at the zoo, and feel confident that they are on the “Z” key. Different tactile feelings for one or more of the keys, such as rough, smooth, furry, etc., will assist the student in memorizing the location of the keys.

It is important to note that the goal of the present invention is to have the student learn to type while focusing on the screen, so that he/she does not realize that their fingers are typing and to do so very quickly. Therefore, the stories and tactile feel of the keys while the student is looking at the screen facilitates that goal. In some instances, the keyboard can be placed on the lap of the student as opposed to a table or desktop to accomplish this goal. Further, the present invention can be used to teach values to the student through the stories told to correlate the stories or words with the computer keyboard keys. It has been found that the present invention enables students to quickly learn to type and improve their expression through written works.

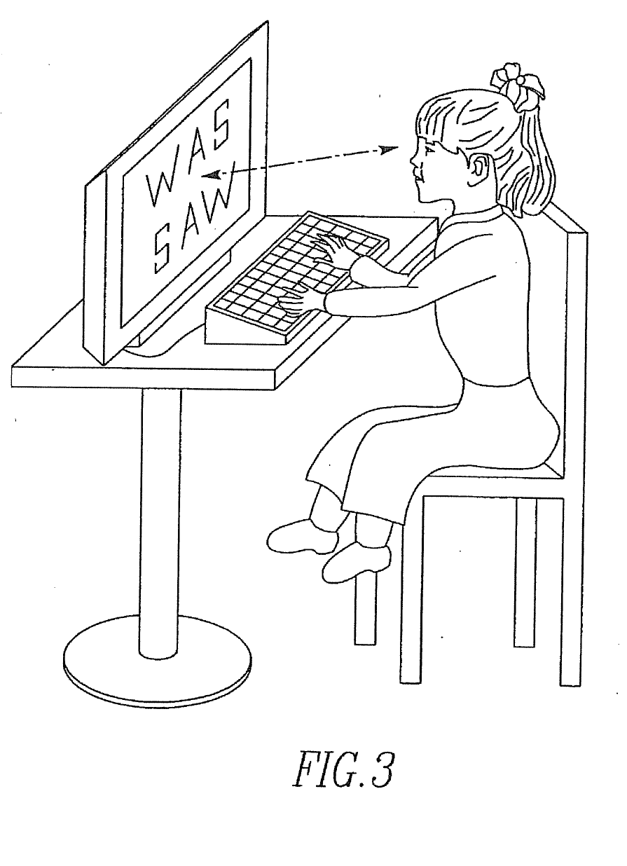

Further, and as shown in FIG. 3, the present method is very liberating to students because they can see the results of what they have learned even before they have mastered the entire keyboard. For example, once the student has undergone the exercise described above with respect to Amy and Sam, they will know the position and relative location of keys “Q”, “A”, “Z”, “W”, “S”, and “X”. Thus, they will already be able to type real words and see them on the monitor or screen, such as “SAW”, “WAS”, “SAX”, and “AX”. This provides the students with an ongoing sense of accomplishment and prompts them to want to learn more key locations. Further, the student has immediate gratification because they can see what they are typing on the screen instantly. As they learn more keys through the method of the present invention, they can begin expanding their horizons and expressing their thoughts and opinions via typing. Additionally, the student does not have to worry about making a permanent mistake or typing the wrong thing because the correction of any errors is not significant to the learning process so that the student does not lose his focus on continuing to look at the screen. Using the keyboard overcomes the fear and nervousness of making mistakes because deleting the mistakes removes them forever and no one has to be aware of them. The interaction between the keyboard, monitor or screen, and the message on the screen is immediate and very direct, so the student can concentrate on the creative process which pencil and paper can sometimes inhibit.

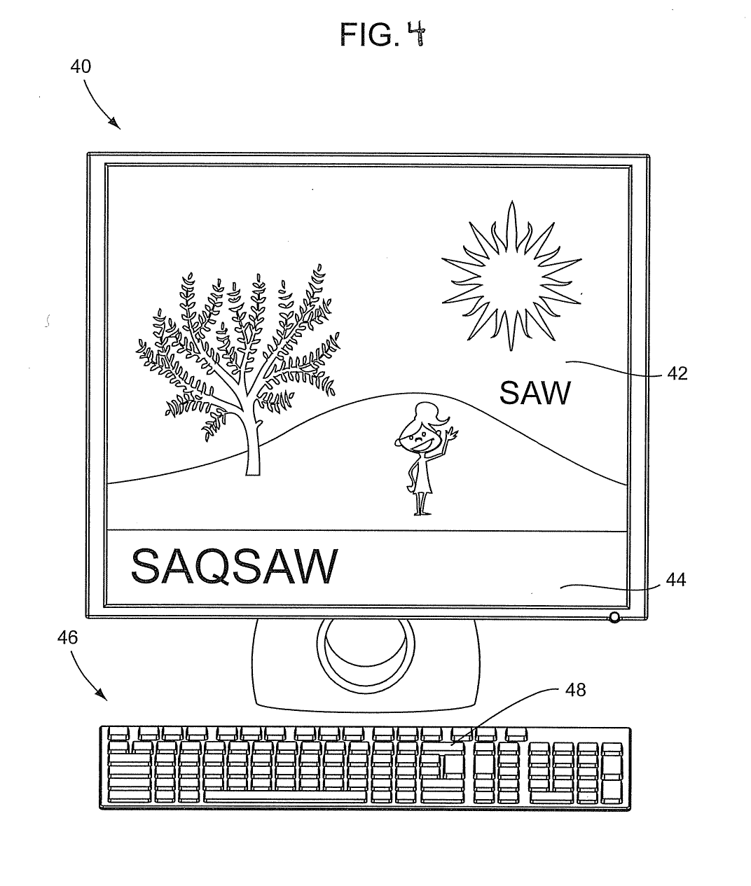

The present invention can also have a split screen interface on the monitor or screen. As shown in FIG. 4, the monitor or screen 40 can be divided into a first portion or top portion 42 and a second portion or bottom portion 44. The first portion 42 can visually display the stories as they unfold, and can also visually prompt the student to type the particular letters, words or phrases as the story moves forward. The story will then prompt the student to type the word “SAW” as shown in FIG. 4. The first portion 42 can show the character playing and prompt the student to type the word “SAW”. When the student attempts to type “SAW”, the letters appear in the second portion 44 of the monitor or screen 40 so that the student can see what letters they have typed.

In another embodiment of the present invention, the delete or backspace key of the keyboard can be inactivated during operation of the program by the student. As shown in FIG. 2, a typical QWERTY computer keyboard includes a backspace key, which can also be referred to as a delete key because it functions by deleting the most recent keystroke. FIG. 4 also shows a QWERTY keyboard 46 having a delete key and/or backspace key 48. With an operational delete key and/or backspace key 48, students can erase and correct the mistakes in their typing, which distracts the students from the teaching feature of the present invention. By inactivating the delete key and/or backspace key 48, students will not be able to correct such mistakes. This preserves the record of all keystrokes entered by the student so that the teacher will know how the student is performing on the typing exercises. In other words, once the letter has been typed it cannot be corrected, erased, or changed from the viewing screen and corrected by the student. As shown in FIG. 4, if the student is prompted to type “SAW” and mistakenly types “SAQ”, the student will not be able to then press the delete key and/or backspace key 48 to delete the “Q” and type a “W”. The student must leave the “SAQ” as is and proceed to correctly type “SAW”. The inactivating of the delete key and/or backspace key can be facilitated by standard software techniques known in the art and therefore will not be discussed in any further detail.

Additionally, the method of the present invention can be tailored to various learning approaches. In general, students learn three different ways: through listening (auditory), seeing (visual) or touch (kinesthetic) means. The method of the present invention can utilize any or all of them. For example, puppets provide the visual stimulus, stories or music can provide the auditory stimulus and materials placed on the keys of a keyboard can provide the kinesthetic stimulus. Also, the method of the present invention can be used to teach a wide range of topics because the stories can be tailored to virtually any type of lesson. For example, the story of Amy going downtown to the Zoo to see the Zebra can be delved into further to discuss visual perception, e.g. “Is the Zebra black with white stripes or white with black stripes?” and moral values, e.g. “The color of the Zebra doesn't tell you anything about the Zebra, just like the color of a person's skin does not tell you anything about the person”. Further, reading, writing, poetry, art and interpersonal relationships can be taught through the method of the present invention.

The method of the present invention can also be used to teach adults, as well as non-English speaking children and adults, keyboarding, reading, and other skills.

The method of the present invention has been tested on a variety of students with overwhelming success. Many students have been able to begin typing and expressing themselves on the screen in a time frame from a few minutes up to an hour. The disclosed method has been shown to increase learning speed and improve learning comprehension for virtually all children, from average learners to gifted children. Also, the method of the present invention has been tested and proven to work and help children with Asperger Syndrome, Dyslexia, and attention-span difficulties. It has been found that the ability to change colors and backgrounds will significantly assist the student to learn how to type. In other words, some students may learn better with a red background, while others may learn better with a blue background. The same also holds true with different colored letters for different students.

The present invention has been described with reference to the preferred embodiments. Obvious modifications, combinations and alterations will occur to others upon reading the preceding detailed description. It is intended that the invention be construed as including all such modifications, combinations and alterations insofar as they come within the scope of the appended claims or the equivalents thereof.

The invention claimed is:

1. A method for teaching a student to type on a computer, comprising the steps of:
a) providing a computer terminal having a first portion and a second portion;
b) providing a keyboard coupled to said terminal;
c) providing a word processing program;
d) correlating keys of the keyboard with stories, wherein the keys of the keyboard represent a fictional town and the stories enable the student to associate a relative location of the keys on the keyboard, and, wherein puppets are used to assist with the step of correlating keys of the keyboard with stories;
e) displaying the stories on the first portion of the terminal; and
f) typing keys on the keyboard and having letters that correlate to the typed keys displayed on the second portion of the terminal for immediate viewing by a student.

2. The method of claim 1, wherein the letters displayed on the terminal are of a sufficient size to be easily read by the student.

3. The method of claim 1, wherein the letters displayed on the terminal include a font style.

4. The method of claim 1, wherein at least one of the keys on the keyboard is texturized.

5. The method of claim 1, wherein the typed keys displayed on the terminal provide an instant gratification for the student.

6. A method for teaching a student to type on a computer, comprising the steps of:
a) telling a student at least one story that correlates individual keys of a keyboard with at least one of a person, place, thing, emotion or expression, wherein the keys of the keyboard represent a fictional town and the at least one story enables the student to associate a relative location of the keys on the keyboard and correlate each key with an appropriate finger of the student to activate the respective key;
b) providing a computer terminal;
c) providing a keyboard having a delete key and/or backspace key coupled to said terminal;
d) providing a word processing program which inactivates the delete key and/or backspace key during operation of the program by the student;
e) having the student place at least one hand on the keyboard; and
f) retelling the at least one story as the student presses individual keys that correlate to the story while viewing the computer terminal, wherein puppets are used to assist with the step of telling of, retelling of, or both, to the at least one story.

7. The method of claim 6, wherein letters that correlate to the pressed keys are displayed on the terminal for immediate viewing by the student.

8. The method of claim 6, wherein the letters displayed on the terminal are of a sufficient size to be easily read by the student.

9. The method of claim 6, wherein the letters displayed on the terminal include a font style.

10. The method of claim 6, wherein at least one of the keys on the keyboard is texturized.

11. The method of claim 1, wherein the keyboard includes a delete key and/or backspace key and the delete key and/or backspace key of the keyboard is inactivated during operation of the program by the student.

12. A system for teaching a student to type on a computer, comprising:
a computer loaded with word processing software and software configured to tell a student at least one story that correlates individual keys of a keyboard with at least one of a person, place, thing, emotion or expression, wherein the keys of the keyboard represent a fictional town and the at least one story enables the student to associate a relative location of the keys on the keyboard and correlate each key with an appropriate finger of the student to activate the respective key;
a computer terminal coupled to the computer, wherein the terminal is configured to display the at least one story and the text typed by the student; and
a keyboard having a delete key and/or backspace key coupled to the terminal;
wherein the system further includes at least one of the following: a) the terminal has a first portion and a second portion, the first portion being configured to display the at least one story and the second portion being configured to display letters associated with the keys typed; or b) the delete key and/or backspace key of the keyboard is inactivated during operation of the program by the student.

13. The method of claim 1, wherein the stories include auditory and visual features.

14. The method of claim 1, wherein the colors of the letters and the backgrounds on the terminal are variable.

15. The method of claim 6, wherein the stories include auditory and visual features.

16. The method of claim 6, wherein the colors of the letters and the backgrounds on the terminal are variable.
